(19) United States
(12) Patent Application Publication
(10) Pub. No.: US 2024/0389503 A1
(43) Pub. Date: Nov. 28, 2024

(54) MANAGEMENT SYSTEM OF INFORMATION ABOUT WORK MACHINE

(71) Applicant: KAWASAKI MOTORS, LTD., Akashi-shi (JP)

(72) Inventors: Hiroyuki KATAOKA, Akashi-shi (JP); Hirokazu MORITA, Akashi-shi (JP); Tomotaka NAKAGAWA, Akashi-shi (JP)

(21) Appl. No.: 18/323,936

(22) Filed: May 25, 2023

(51) Int. Cl. A01D 34/00

(52) U.S. Cl. CPC A01D 34/008; A01D 2101/00

(57) ABSTRACT

A management system 1 includes an electronic controller 14 and a communicator 15.The electronic controller 14 is arranged at a self-propelled lawn mower 10 and performs a drive control of a drive source 11 that drives the lawn mower 10. The communicator 15 is arranged at the lawn mower 10, includes an apparatus that communicates with the electronic controller 14 and with a server 30 via a network, acquires drive control information used for the drive control from the electronic controller 14, and transmits the drive control information to the server 30.

### TECHNICAL FIELD

The present application mainly relates to a management system that manages information acquired from a work machine such as a lawn mower by consolidating the information on a server.

### BACKGROUND ART

PTL 1, U.S. patent publication No. 2021/0382476, discloses a system that acquires and manages information on whether an engine of a lawn mower or the like is running or not.

### SUMMARY OF THE INVENTION

The information on whether the engine is running or not alone was not sufficient to manage work machines including a lawn mower.

The present application is made in view of the situation described above and its main purpose is to provide a management system that can acquire sufficient information necessary for management of a work machine such as a lawn mower.

The problem to be solved by the present application is as described above. The means to solve this problem and the effects thereof will be described below.

A first aspect of the present disclosure provides a management system with a configuration described below. That is, the management system includes an electronic controller and a communicator. The electronic controller is arranged at a self-propelled lawn mower and performs a drive control of a drive source that drives the lawn mower. The communicator is arranged at the lawn mower, includes an apparatus that communicates with the electronic controller and communicates with a server via a network, acquires drive control information used for the drive control from the electronic controller, and transmits the drive control information to the server.

A second aspect of the present disclosure provides a method as described below. That is, the method is a transmission method of information about lawn mowing to a user or a dealer of a self-propelled lawn mower. The method includes receiving a drive control information used for a drive control of a drive source that drives the lawn mower. The method includes transmitting information about lawn mowing generated by processing the drive control information according to the user to the user's client terminal, or transmitting information about lawn mowing generated by processing the drive control information according to the dealer to the dealer's client terminal.

A third aspect of the present disclosure provides a management system with a configuration described below. That is, the management system includes an electronic controller and a communicator. The electronic controller is arranged at a self-propelled work machine and performs a drive control of a drive source that drives the work machine. The communicator is arranged at the work machine, includes an apparatus that communicates with the electronic controller and communicates with a server via a network, acquires drive control information used for the drive control from the electronic controller, and transmits the drive control information to the server.

### EFFECTS OF THE INVENTION

According to the present application, a management system that acquires sufficient information necessary for management of a work machine such as a lawn mower is provided.

### BRIEF DESCRIPTION OF THE DRAWINGS

FIG. 1 is a block diagram of a management system.

FIG. 2 is a diagram illustrating information transmitted from a lawn mower to a server.

FIG. 3 is a flowchart illustrating a process performed when a lawn mower transmits information to a server.

FIG. 4 is a diagram illustrating information transmitted from a user's client terminal and a dealer's client terminal to a server.

FIG. 5 is a table illustrating databases stored in a server.

FIG. 6 is a flowchart illustrating a process performed when a server registers received information and transmits information.

FIG. 7 is a diagram illustrating information transmitted from a server to a user's client terminal and a dealer's client terminal.

FIG. 8 is a flowchart illustrating a process performed when a server generates maintenance information.

FIG. 9 is a flowchart illustrating a process performed when a server generates area deviation information.

FIG. 10 is a flowchart illustrating a process performed when a server generates area analysis information.

FIG. 11 is a flowchart illustrating a process performed when a server generates route information.

### EMBODIMENT FOR CARRYING OUT THE INVENTION

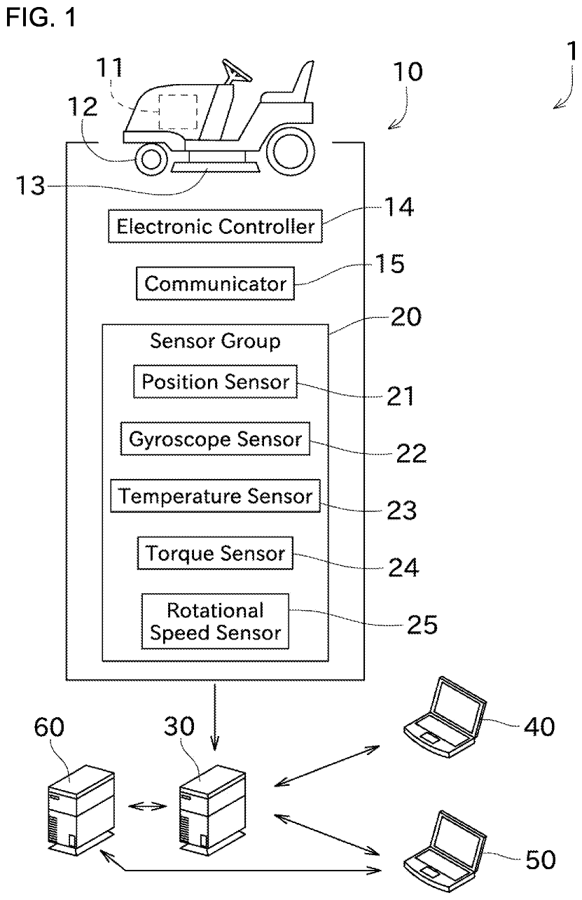

First, an outline of a management system 1 of the present embodiment will be described below with reference to FIG. 1. The management system 1 manages information about a lawn mower 10. The information about the lawn mower 10 is consolidated on a server 30. The server 30 communicates with the lawn mower 10 and receives and stores the information about the lawn mower 10. The server 30 communicates with a user terminal 40 which is used by a user of the lawn mower 10 and a dealer terminal 50 which is used by a dealer of the lawn mower 10 and receives and stores the information about the lawn mower 10. The server 30 transmits the information about the lawn mower 10 to the user terminal 40 or the dealer terminal 50 upon request from the user terminal 40 or the dealer terminal 50. When information about a part of the lawn mower 10 is needed, the server 30 communicates with a parts management system 60 to acquire the information about the part of the lawn mower 10. The server 30 is also capable of generating new information based on the information about the lawn mower 10, as described later.

Configurations of the lawn mower 10, the server 30, the user terminal 40, the dealer terminal 50, and the parts management system 60 will be described below.

The lawn mower 10 mows a lawn. Lawn mowing is an act of cutting grass growing on the lawn. Since the lawn mower 10 is self-propelled, it includes a configuration to propel itself. Specifically, the lawn mower 10 includes a drive source 11 and wheels 12. The drive source 11 is an engine. The drive source 11 generates power by burning a fuel. The power generated by the drive source 11 is transmitted to the wheels 12. In this manner, the lawn mower 10 moves. The engine may be, for example, a gasoline engine or a diesel engine. The drive source 11 may be an electric motor or may be comprised of both an engine and an electric motor.

The lawn mower 10 further includes a mower blade unit 13. The mower blade unit 13 includes a rotary mower blade. The power generated by the drive source 11 is transmitted to the mower blade unit 13. In this manner, the mower blade of the mower blade unit 13 rotates and cuts the grass.

The lawn mower 10 includes a steering wheel and a seat. An operator sits on the seat of the lawn mower 10 and operates the steering wheel. The lawn mower 10 may be configured in such a way that the operator stands on the lawn mower 10. The lawn mower 10 may include a steering lever instead of the steering wheel. The lawn mower 10 may be configured to be remotely operated by the operator. The lawn mower 10 may be configured to be autonomous so that it does not require operation by the operator.

The lawn mower 10 includes an electronic controller 14. The electronic controller 14 is an electronic apparatus that controls the drive source 11. Specifically, the electronic controller 14 is a microcomputer that includes a CPU, a main memory, and storage. The CPU loads a program and control data stored in the storage into the main memory and executes it. In this manner, the electronic controller 14 performs a drive control. The drive control is a control for operating the drive source 11 and may be, for example, a control related to fuel injection.

The lawn mower 10 includes a communicator 15. The communicator 15 may be, for example, a TCU. TCU stands for Telematics Control Unit. The communicator 15 includes a communication circuit. The communication circuit communicates via a mobile network using an internal antenna or an external antenna. In other words, the communicator 15 can directly connect to the Internet without a router or a smartphone. The communicator 15 transmits information to the server 30 according to a command from the electronic controller 14.

The communicator 15 may also be indirectly connected to the Internet. For example, the communicator 15 may communicate with a smartphone via proximity wireless communication. Alternatively, the communicator 15 may be connected to a PC via wired or wireless communication. In this manner, the communicator 15 can connect to the Internet via the smartphone.

The lawn mower 10 includes a sensor group 20. The sensor group 20 collectively means sensors that detect the information about the lawn mower 10. Each of the sensors that comprise the sensor group 20 is arranged at, for example, the body of the lawn mower 10, the drive source 11, the electronic controller 14, or the communicator 15. Sensor data detected by each of the sensors that comprises the sensor group 20 is output to the electronic controller 14. The sensor group 20 includes a position sensor 21, a gyroscope sensor 22, a temperature sensor 23, a torque sensor 24, and a rotational speed sensor 25. Sensors different from those described above may be included in the sensor group 20.

The position sensor 21 is a GNSS sensor and includes a GNSS antenna and a GNSS receiver. The GNSS receiver calculates the latitude and longitude of the position of the lawn mower 10 based on signals received by the GNSS antenna from satellites. The gyroscope sensor 22 is a triaxial angular velocity sensor. The gyroscope sensor 22 detects angular velocities with respect to three axes of the lawn mower 10. Instead of the gyroscope sensor 22, an inertial measurement unit may be arranged. The inertial measurement unit is a sensor unit that detects angular velocities with respect to three axes and acceleration in three directions. The temperature sensor 23 detects temperature with respect to the drive source 11. The temperature sensor 23 detects, for example, intake air temperature, exhaust air temperature, coolant temperature, or engine room temperature. The torque sensor 24 detects the torque of the drive source 11. The torque sensor 24 may be, for example, a strain gauge installed on a drive shaft of the drive source 11. The rotational speed sensor 25 detects rotational speed of the drive source 11. The rotational speed sensor 25 may be, for example, a rotation sensor installed on the drive shaft of the drive source 11.

The server 30 is a computer that includes a CPU, a main memory, and storage. The CPU loads a program and control data stored in the storage into the main memory and executes it. In this manner, the server 30 controls the processing of the information about the lawn mower 10. The server 30 also includes a wired communication unit that connects to the Internet via a router or the like. With this configuration, the server 30 can communicate with the lawn mower 10, the user terminal 40, and the dealer terminal 50 via the Internet. The server 30 may be comprised of a single hardware unit. Alternatively, more than one hardware unit may work together to perform the functions of the server 30.

The user terminal 40 is a client terminal used by the user of the lawnmower 10. The operator terminal 50 is a client terminal used by the operator of the lawnmower 10. The client terminal is a computer that includes a CPU, a main memory, and storage, as the server 30. Specifically, the client terminal is a PC, a smartphone, or a tablet device. The client terminal may be a general-purpose product with other uses or a product specialized for the management system 1 only.

The user of the lawn mower 10 is a person who uses the lawn mower 10 to mow the lawn. Specifically, the user is a landscaping company that is compensated for providing lawn mowing as a service upon a request from an owner of the lawn. The user may own the lawn mower 10 or may borrow the lawn mower 10 from another party. The user is not limited to the landscaping company as described above, but may also be a person who mows their own lawn.

The dealer of the lawn mower 10 is a person or an entity that deals with the lawn mower 10. The dealer sells or rents out the lawn mower 10 to the user or does maintenance on the lawn mower 10.

In FIG. 1, one user terminal 40 and one dealer terminal 50 are illustrated. In fact, however, the server 30 sends and receives information to and from more than one user terminal 40 and more than one dealer terminal 50. In other words, in the management system 1, information about the lawn mowers 10 that multiple users use and information about the lawn mowers 10 that multiple dealers deal with is consolidated on the server 30.

The parts management system 60 is a system for dealing with parts of the lawn mower 10. The parts management system 60 is comprised of a plurality of servers connected to the Internet. The parts management system 60 manages the provision of the parts of the lawn mower 10. The parts of the lawn mower 10 include a replacement part to be replaced when damaged, and a consumable part to be replaced periodically.

The parts management system 60 receives an order for a part of the lawn mower 10 via the Internet. The parts management system 60 arranges the preparation and the shipping of the part ordered. The dealer can access the parts management system 60 using the dealer terminal 50 to order a part of the lawn mower 10. Furthermore, the server 30 is connected to the parts management system 60 via the Internet. Therefore, the dealer can also access the server 30 using the dealer terminal 50 and order the part of the lawn mower 10. The parts management system 60 provides the server 30 with information including a list of parts compatible with the lawn mower 10, inventory status thereof, and their prices.

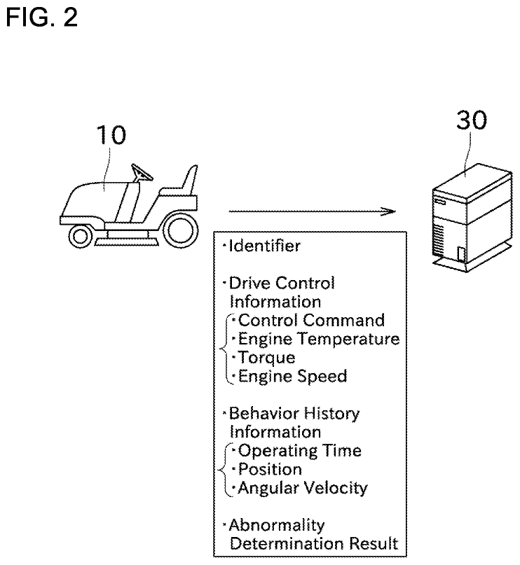

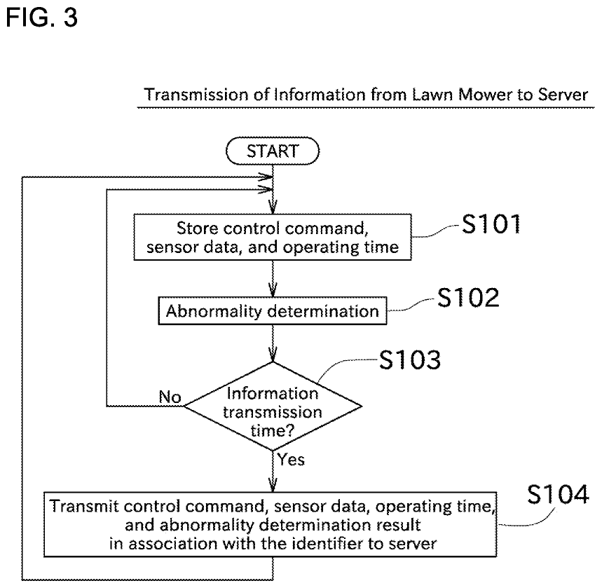

Then, a process performed when the lawn mower 10 transmits information to the server 30 will be described below with reference to FIG. 2 and FIG. 3.

FIG. 2 shows an example of information transmitted from the lawn mower 10 to the server 30. Specifically, the information includes an identifier, drive control information, behavior history information, and an abnormality determination result. Each of these pieces of information is described in detail below.

The identifier is a character string that is uniquely assigned to the lawn mower 10. The character string includes, for example, a letter, a number, or a symbol. The identifier may be, for example, a serial number of the lawn mower 10, the drive source 11, or the electronic controller 14. The management system 1 uses the identifier to distinguish the lawn mowers 10.

The drive control information is information that is used for the drive control. Specifically, the drive control information includes a control command, engine temperature, torque, or engine speed. However, the drive control information may also include information other than these. The control command is a command that the electronic controller 14 outputs to the drive source 11. Since the electronic controller 14 of the present embodiment performs control on fuel injection, the control command is information that indicates change of the amount of the fuel injected over time. In the case where the drive source 11 is an electric motor, the control command is information that indicates change of current that drives the motor over time. The engine temperature is information detected by the temperature sensor 23. The torque is information detected by the torque sensor 24. The engine speed is information detected by the rotational speed sensor 25.

Since the drive control information is used for the drive control on the drive source 11, the drive control information indicates the state of the drive source 11 and the operation of the drive source 11. Therefore, the output required by the lawn mower 10 and the history of the actual output can be inferred based on the drive control information. As will be described in detail later, the drive control information is used to predict the failure of the parts of the lawn mower 10.

The behavior history information is information that indicates the history of the behavior of the lawn mower 10. Specifically, the behavior history information includes operating time, position, or angular velocity. The behavior history information may also include other information. The operating time is the total time for which the lawn mower 10 has operated. The operating time is calculated using an internal clock of the electronic controller 14. The position is information that is detected by the position sensor 21. The angular velocity is information that is detected by the gyroscope sensor 22.

Using the behavior history information enables estimation of the time for which the lawn mower 10 has mowed the lawn, the positions at which it mowed, its posture when the lawn mower 10 was mowing the lawn, or impact it received. As will be described in detail later, the behavior history information is used to determine whether or not the lawn mower 10 is located in an appropriate operation area or to analyze what characteristics the operation area has.

The abnormality determination result is a result of determination made by the electronic controller 14 on whether the drive source 11 has an abnormality. The electronic controller 14 determines whether the drive source 11 has an abnormality based on whether or not the sensor data output from the each sensor of the sensor group 20 exceeds a threshold.

FIG. 3 is a flowchart illustrating the transmission of information form the lawn mower 10 to the server 30. The flowchart in FIG. 3 is executed by the electronic controller 14. The electronic controller 14 stores the control command, the sensor data, and the operating time in the storage while the lawn mower 10 is in operation (S101). The electronic controller 14 performs the above-mentioned abnormality determination (S102).

Then, the electronic controller 14 determines whether or not it is information transmission time: the time to transmit information (S103). In the present embodiment, since the lawn mower 10 includes the communicator 15 that can connect to the mobile network, the electronic controller 14 can transmit information to the sever 30 while the lawn mower 10 is in operation. In other words, the electronic controller 14 transmits information to the server 30 while electricity is supplied to the electronic controller 14. Therefore, the information transmission times are set, for example, at predetermined intervals during the operation of the lawn mower 10. With this configuration, the electronic controller 14 can transmit information to the server 30 in real time. In the present specification, even when there is a slight difference between a time at which the electronic controller 14 acquires information and a time at which it transmits the information, the transmission is defined as done “in real time.”

The electronic controller 14 may transmit the information to the server 30 after the lawn mower 10 finished operating. In this case, the electronic controller 14 determines a time at which the lawn mower 10 has finished operating and is connected to the PC or other device as the information transmission time.

Alternatively, the electronic controller 14 may vary the information transmission time depending on the information to be transmitted. For example, the information transmission times for transmitting information of high urgency may be set at predetermined interval during the operation of the lawn mower 10. And the information transmission time for transmitting less urgent information may be set after the lawn mower 10 finished operating. The information of high urgency includes, for example, information that is determined to be abnormal by the abnormality determination, or area deviation information that will be described below.

When the electronic controller 14 determines that the information transmission time has come, the electronic controller 14 transmits the control command, the sensor data, the operating time, and the abnormality determination result in association with the identifier to the server 30 using the communicator 15 (S104).

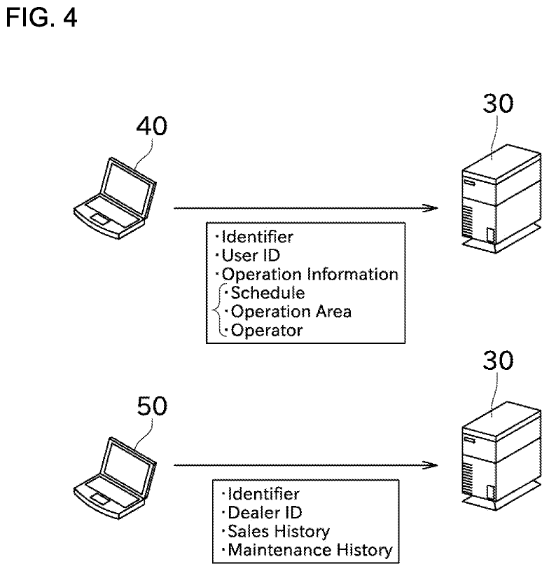

Then, the process of transmitting information from the user terminal 40 and the dealer terminal 50 to the server 30 will be described with reference to FIG. 4.

FIG. 4 shows an example of information transmitted from the user terminal 40 and the dealer terminal 50 to the server 30. Specifically, the user terminal 40 transmits the identifier, a user ID, and operation information to the server 30. The dealer terminal 50 transmits the identifier, a dealer ID, a sales history, and a maintenance history to the server 30. Each of these pieces of information will be described in detail below.

The identifier is as same as the described above. The user acquires the identifier from, for example, a document issued at the time of purchase of the lawn mower 10 and registers it in the user terminal 40. The dealer acquires the identifier from, for example, a document issued at the time of buying of the lawn mower 10 and registers it in the dealer terminal 50.

The user ID is a character string that is uniquely assigned to the user. The dealer ID is a character string that is uniquely assigned to the dealer. These character strings include, for example, a letter, a number, or a symbol. The user ID and the dealer ID are assigned by an administrator of the management system 1 when they start using the system. The management system 1 uses the user ID to distinguish the users and uses the dealer ID to distinguish the dealers.

The operation information is information about the lawn mowing that the user performs using the lawn mower 10. In the present embodiment, it is information about the lawn mowing that the user, a landscaping company, has received from a customer. Specifically, the operation information includes information about a time schedule of mowing, about an operation area of which the lawn is to be mowed, and about an operator who actually mows the lawn. For example, an area specified by the user using a mapping software or the like is treated as one section of the operation area.

The sales history is a history of the sales of the lawn mowers 10 by the dealer. The sales history includes the user ID of the user who purchased the lawn mower 10, the identifier of the sold lawn mower 10, and the time of the purchase.

The maintenance history is a history of the maintenances performed on the lawn mower 10 by the dealer. The maintenance history includes details of the maintenance, the identifier of the lawn mower 10 that received the maintenance, and the time of the maintenance. The details of the maintenance includes information that identifies a replaced part, information that identifies changed consumables, such as oil, and information that identifies an area that were cleaned or checked.

When the user terminal 40 and the dealer terminal 50 receive a command to transmit the information described above or determine that it is time to transmit the information described above, they transmit the information described above to the server 30.

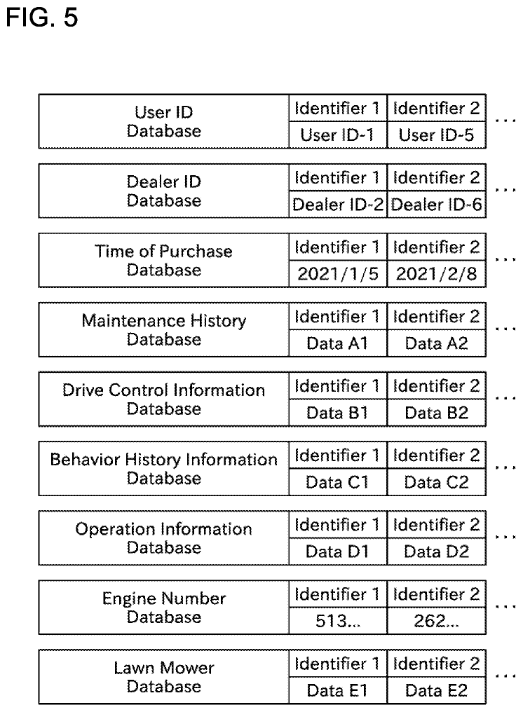

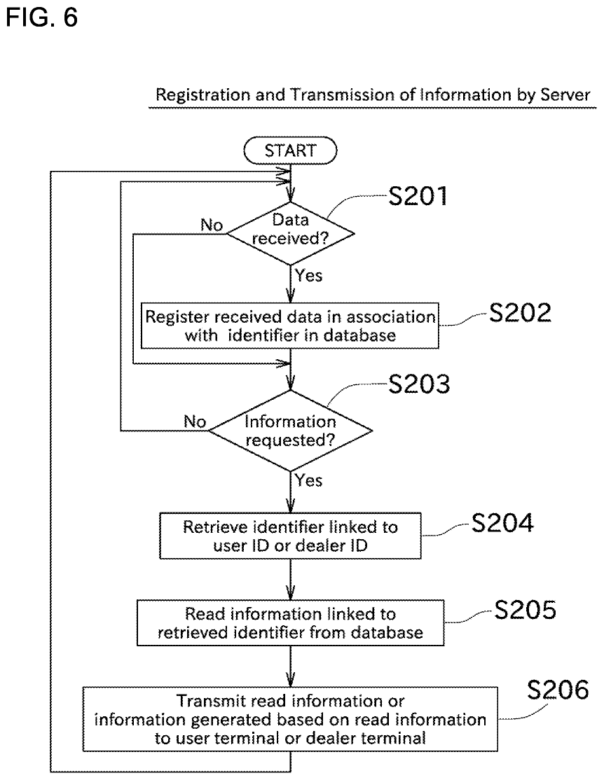

Then, with reference to FIG. 5 and FIG. 6, the database created by the server 30 will be described below.

The server 30 stores the identifier of the lawn mower 10 in association with the user ID, the dealer ID, the time of the purchase, the maintenance history, the drive control information, the behavior history information, and the operation information received from the lawn mower 10, the user terminal 40, and the dealer terminal 50. Since all the lawn mowers 10 are assigned different identifier, the information described above can be organized and managed efficiently by using the identifier. The table in FIG. 5 is shown for the sake of clarity in describing the correspondence of the information with the identifier and it does not show the actual database structure.

Furthermore, FIG. 5 shows databases related to engine number and lawn mower information.

The engine number is a number that is uniquely assigned to the engine. When the engine number is used as the identifier, the database of the engine numbers may be omitted. The server 30 receives the correspondence between the identifier of the lawn mower 10 and the engine number from, for example, a system of the manufacturer of the lawn mower 10 or that of the drive source 11. Alternatively, the server 30 may receive the correspondence between the identifier of the lawn mower 10 and the engine number form the user terminal 40 or the dealer terminal 50. The server 30 registers the correspondence between the identifier of the lawn mower 10 and the engine number received as described above in the database.

The lawn mower information is various information about the lawn mower 10. The lawn mower information includes, for example, parts information, new model information, recall information, and review information. The lawn mower information may be linked with the identifier of the lawn mower 10 or with a model number of the lawn mower 10. If the model and version of the lawn mowers 10 are the same, they are assigned the same model number. In this manner, the lawn mower information is organized efficiently. The parts information is information including a list of parts compatible with the lawn mower 10, inventory status thereof, and their prices. The server 30 receives the parts information from the parts management system 60. The server 30 receives the new model information and the recall information from the manufacturer of the lawn mower 10. The review information is reviews from the user about the lawn mower 10 or information acquired by aggregating the reviews. The review information is collected directly or acquired via the Internet by the manufacturer of the lawn mower 10, an operator of the management system 1, or a group related to the lawn mower 10.

Steps S201 and S202 of the flowchart shown in FIG. 6 depict the processes that the server 30 performs with respect to the registration in the database. When the server 30 determines that data has been received from the lawn mower 10, the user terminal 40, or the dealer terminal 50 (S201), the server 30 registers the received data in association with the identifier of the lawn mower 10 in the database (S202).

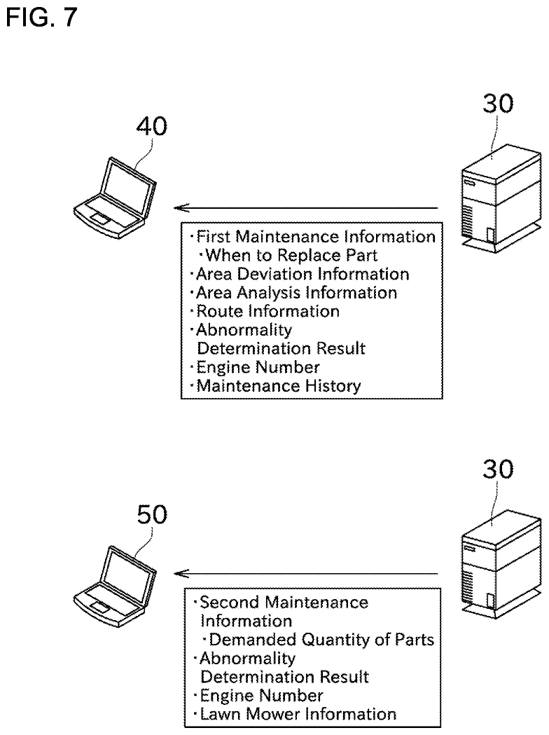

Then, with reference to FIGS. 6 and 7, the process of transmitting information from the server 30 to the user terminal 40 or the dealer terminal 50 will be described below.

Steps S203 through S206 of the flowchart shown in FIG. 6 depict the processes that are performed when the server 30 transmits information in response to a request from the user terminal 40 or the dealer terminal 50. The server 30 determines whether there is a request for information from the user terminal 40 or the dealer terminal 50 (S203). When the server 30 determines that there is a request for information, it identifies the user ID or the dealer ID. The server 30 accesses the database and retrieves the identifier of the lawn mower 10 linked to the user ID or the dealer ID (S204). If more than one identifier is linked to the user ID or dealer ID identified, the server 30 retrieves all the linked identifier. Then, the server 30 reads information linked to the retrieved identifier from the database (S205). The server 30 transmits the read information or information generated based on the read information to the user terminal 40 or the dealer terminal 50 (S206).

Then, the form of the transmission of the information by the server 30 will be described below. The management system 1 is, for example, a web application. By operating the user terminal 40, the user accesses a website provided by the server 30. The user enters their user ID and password and logs in. Since the same is true on the dealer as on the user, the description thereof is omitted. After logging in, the user clicks a predetermined link to open a page for acquiring information about the lawn mower 10. For example, when the user clicks on a link associated with the maintenance history, the server 30 retrieves the identifier of the lawn mower 10 linked to the user ID. The server 30 generates a page to show the maintenance history linked to the retrieved identifier. The page of the maintenance history is displayed on the display screen of the user terminal 40. This completes the transmission of the information from the server 30 to the user terminal 40. The management system 1 is not limited to a web application, but may be a desktop application or a mobile application.

In the present embodiment, the server 30 transmits information to the user terminal 40 or the dealer terminal 50 upon request from the user terminal 40 or the dealer terminal 50 for the information. Alternatively, the server 30 may determine whether or not it is the information transmission time to transmit the information and transmit the information to the user terminal 40 or the dealer terminal 50 when it determines that it is. For example, when the server 30 receives information of high urgency including the abnormality determination result or area deviation information which is described below, the server 30 may immediately transmit the information to the user terminal 40 or the dealer terminal 50.

FIG. 7 shows examples of pieces of information transmitted from the server 30 to the user terminal 40 or the dealer terminal 50. Specifically, the server 30 transmits first maintenance information, the area deviation information, area analysis information, route information, the abnormality determination result, the engine number, the maintenance history, and the lawn mower information to the user terminal 40. The server 30 transmits second maintenance information, the abnormality determination result, the engine number, and the lawn mower information to the dealer terminal 50.

The first maintenance information is information about maintenance on the user's lawn mower 10. The first maintenance information is information customized for the user. The first maintenance information is, for example, information that indicates when to replace a part of the user's lawn mower 10. When the user owns more than one lawn mower 10, the first maintenance information indicates each of times for replacement of the parts corresponding to each lawn mowers 10. The calculation method of the first maintenance information will be described below. The first maintenance information may further include inventory status of the parts and prices thereof.

The second maintenance information is information about maintenance customized for the dealer. The second maintenance information includes, for example, demanded quantity of the parts of the lawn mower 10. The demanded quantity of the parts of the lawn mower 10 is the total quantity of the parts that the dealer needs now and in the future for the lawn mower 10 that the dealer deals with. The demanded quantity of the parts of the lawn mower 10 is given to the dealer with respect to each type of the parts. In the present embodiment, the demanded quantity of the parts included in the second maintenance information is the demanded quantity of the parts for the lawn mowers 10 that the dealer actually sold or rented out. However, the second maintenance information may indicate demanded quantity of the parts for all the lawn mowers 10 that are managed by the management system 1. This is because the dealer may well sell parts for the lawn mower 10 that they did not sell or rent out. The calculation method of the second maintenance information will be described below. The second maintenance information may further include inventory status of the parts and prices thereof.

The area deviation information is information that indicates whether the user's lawn mower 10 is deviating from the operation area or not. If it is deviating from the operation area, it means that the lawn mower 10 is traveling in an area that the user is not requested to mow. For example, the operator of the lawn mower 10 may not have an accurate grasp of the operation area. Or, the lawn mower 10 may have been stolen. The calculation method of the area deviation information will be described below.

The area analysis information is information acquired by analyzing the operation area. The area analysis information includes, for example, degree of inclination of the operation area, position of the operation area that the operator should beware of while mowing, time required to finish mowing the operation area, and difficulty of mowing. The area analysis information is information generated based on the behavior history information consolidated on the server 30. By referring to the area analysis information of the area that is to be mowed, the user can mow the lawn efficiently and make a suitable schedule. The calculation method of the area analysis information will be described below.

The route information is information about a route along which the lawn mower 10 travels when mowing the operation area. The route information may be, for example, information that indicates a path the lawn mower 10 travels as a line on a map, or information that indicates a position that the lawn mower 10 travel around as a point on the map. In the present embodiment, the sever 30 generates an appropriate route and transmits it to the user terminal 40 as the route information. The appropriate route is, for example, a route that requires less time to mow the lawn. However, the appropriate route may also be a route that tends to reduce the difficulty of the lawn mowing. The appropriate route may be a route that tends to enhance the quality of lawn mowing. The calculation method of the route information will be described below.

The abnormality determination result, the engine number, the maintenance history, and the lawn mower information are as described above. These pieces of the information are registered in the database of server 30.

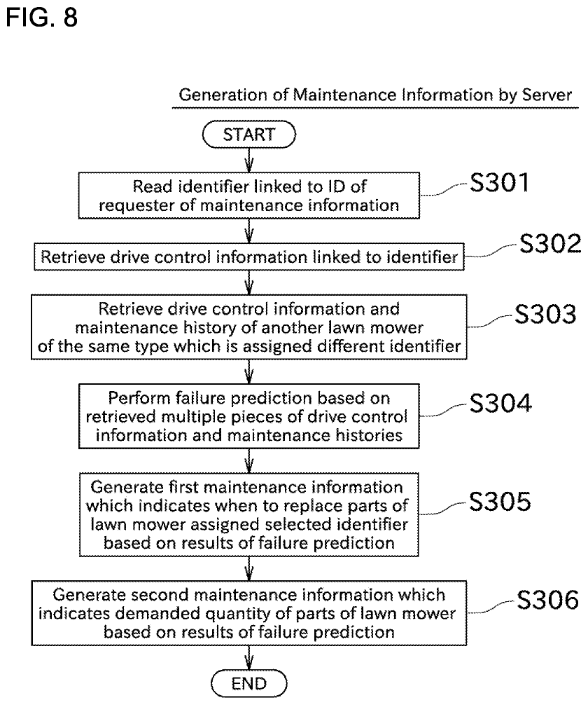

Then, with reference to FIG. 8, the process of generating the first maintenance information and the second maintenance information will be described below. Hereinafter, the first maintenance information and the second maintenance information will be collectively referred to as the maintenance information.

Upon receiving a request for the maintenance information, the server 30 reads the identifier of the lawn mower 10 linked to the ID of the requester of the maintenance information from the database (S301). If the request is made by the user, the server 30 reads the identifier linked to the user ID. If the request is made by the dealer, the server 30 reads the identifier linked to the dealer ID.

Then, the server 30 retrieves the drive control information linked to the read identifier from the database (S302). The maintenance information is generated based on the drive control information. The server 30 also retrieves the drive control information and the maintenance history of another lawn mower 10 of the same type as the lawn mower 10 assigned the read identifier which is assigned a different identifier from the read identifier (S303). Step S303 is a process to increase the number of samples to improve the accuracy of failure prediction and is not an essential process.

Then, the server 30 performs the failure prediction based on the retrieved multiple pieces of drive control information and maintenance histories (S304). Generally, parts of a machine such as the lawn mower 10 deteriorate due to various factors. Main factors are, for example, passage of time, high temperature, and heavy load. Based on the drive control information, the temperature of the drive source 11 and the load applied to it for each driving time can be determined. That is, the temperature of the drive source 11 can be determined from the sensor data output from the temperature sensor 23. The load applied to the drive source 11 can be determined from at least one of the control command, the torque, or the engine speed. A rough guide of when the parts of the lawn mower 10 should be replaced is provided by the manufacturer of the lawn mower 10. Therefore, the failure prediction can be made by comparing the condition provided by the manufacturer of the lawn mower 10 where the parts need replacement with the results of analysis of the drive control information. The failure prediction is an estimation of when each part of the lawn mower 10 fails.

In particular, in the present embodiment, based on the information retrieved in step S303, relationship between the drive control information and the maintenance history for the same type of the lawn mower 10 can be acquired. The maintenance history includes a history of replacement of the parts and a history of failure of the parts. Therefore, the server 30 can perform the failure prediction with even higher accuracy.

Then, based on the results of the failure prediction, the server 30 generates the first maintenance information which indicates when to replace the parts of the lawn mower 10 that is assigned the selected identifier (S305). In other words, the first maintenance information is information about one or more lawn mowers 10 used by the user.

Then, based on the results of the failure prediction, the server 30 generates the second maintenance information which indicates the demanded quantity of the parts of the lawn mower 10 (S306). The second maintenance information is information about one or more lawn mowers 10 sold or rented out by the dealer. As mentioned above, the second maintenance information may indicate demanded quantity of the parts for all the lawn mowers 10 that are managed by the management system 1.

As described above, the server 30 performs different processes to generate different information for the user and for the dealer. This allows the management system 1 to provide information to the user and the dealer as they request.

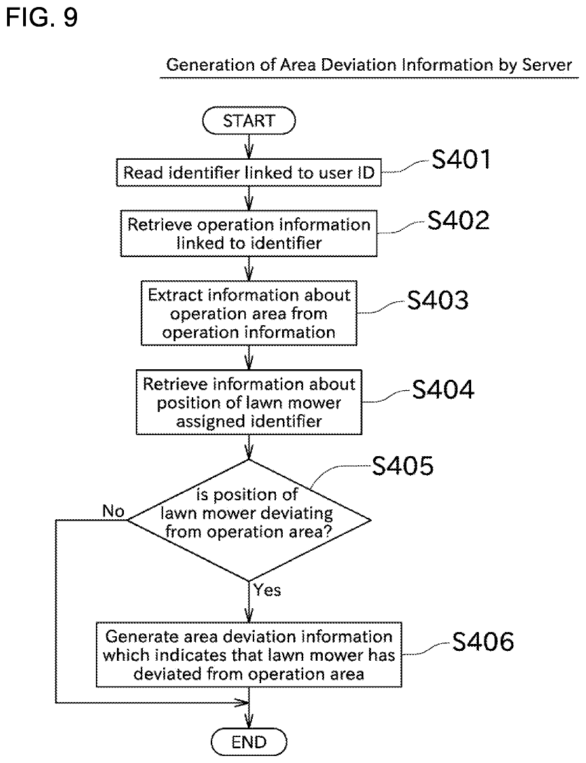

Then, with reference to FIG. 9, the process of generating the area deviation information will be described below.

As described above, the area deviation information is information which indicates whether or not the user's lawn mower 10 is deviating from the operation area. Upon receiving a request for the area deviation information, the server 30 identifies the user ID and read the identifier of the lawn mower 10 linked to the user ID from the database (S401). Then, the server 30 retrieves the operation information linked to the read identifier (S402). As described above, the operation information includes information about the operation area to be mowed. The server 30 extracts the information about the operation area to be mowed from the retrieved operation information (S403).

Then, the server 30 retrieves information about the position of the lawn mower 10 that is assigned the read identifier from the database (S404). That is, the sever 30 receives the behavior history information of the lawn mower 10 from the user terminal 40 and registers it in the database. The behavior history information includes the position of the lawn mower 10. Thus, the server 30 can identify the position of the lawn mower 10.

Then, the server 30 determines whether the position of the lawn mower 10 is deviating from the operation area (S405). Specifically, the server 30 determines that the lawn mower 10 is deviating from the operation area if its position identified in step S404 is out of the operation area identified in step S403. When the server 30 determines that the lawn mower 10 is deviating from the operation area, the server 30 generates the area deviation information that indicates that the lawn mower 10 has deviated from the operation area (S406).

As described above, if the lawn mower 10 is deviating from the operation area, the operator of the lawn mower 10 may not have an accurate grasp of the operation area, or the lawn mower 10 may have been stolen. Therefore, transmitting the area deviation information to the user allows the user to deal with the problem.

Considering the purpose of the area deviation information, it is preferable to generate the area deviation information in real time while the lawn mower 10 is in operation. However, the area deviation information is also used after the operation to examine whether the lawn mower 10 was operating in the appropriate area. Therefore, the area deviation information may be generated after the operation of the lawn mower 10 finished.

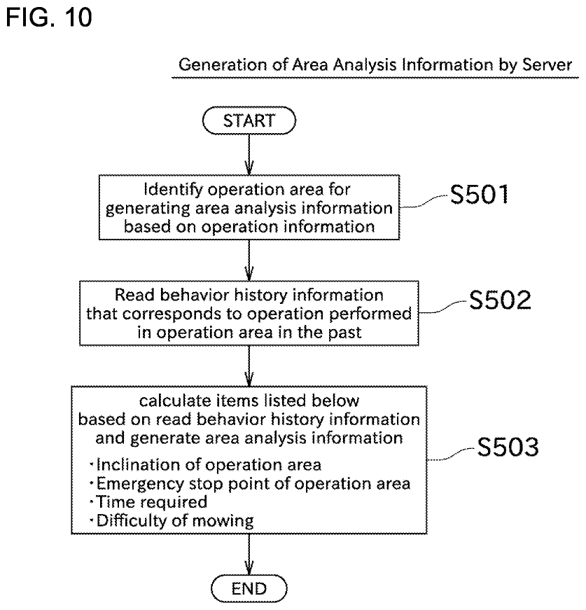

Then, with reference to FIG. 10, the process of generating the area analysis information will be described below.

The area analysis information is information acquired by analyzing the operation area. The server 30 may generate or revise the area analysis information when requested by the user. Alternatively, the server 30 may also generate or revise the area analysis information periodically, regardless of whether or not the user requests it.

First, based on the operation information, the server 30 identifies the operation area for generating the area analysis information (S501). If requested by the user, the server 30 identifies the operation area in which the user is scheduled to perform the operation. In the case where the server 30 generates the area analysis information regardless of whether the user requests it, the server 30 identifies all of the operation areas in sequence and generates the area analysis information.

Then, the server 30 reads the behavior history information that corresponds to the operation performed in the operation area in the past (S502). The behavior history information includes information about the position of the lawn mower 10. Therefore, by comparing the position of the identified operation area and the position included in the behavior history information, the server 30 can identify the correspondence between the operation area and the behavior history information.

Then, based on the read behavior history information, the server 30 calculates the inclination of the operation area, an emergency stop point of the operation area: a point where the lawn mower 10 emergently stopped, time required, and the difficulty of mowing, and generates the area analysis information (S503).

The inclination of the operation area can be calculated based on the sensor data output from the gyroscope sensor 22 included in the behavior history information. By linking the sensor data output from the position sensor 21 to the sensor data output form the gyroscope sensor 22, the direction and degree of the inclination corresponding to the position of the operation area can be calculated. If there is no need to calculate the inclination that corresponds to the position, only the maximum inclination of the operation area may be calculated, or only the average degree of the inclination may be calculated. If the operation area is inclined, the difficulty of mowing may increase or the time required may increase according to the degree of the inclination.

The emergency stop point of the operation area can be calculated using the sensor data output form the position sensor 21 according to the operating time. That is, if the state of the lawn mower 10 changes from that where the position of the lawn mower 10 is changing as the operating time elapses, i.e. the state where the lawn mower 10 is traveling, into that where the position of the lawn mower 10 does not change even if the operating time elapses, the server 30 determines that the lawn mower 10 made an emergency stop at that point. The emergency stop point may be calculated by using the sensor data output from a traveling speed sensor of the lawn mower 10 and the sensor data output from the position sensor 21. Alternatively, if the lawn mower 10 includes the inertial measurement unit, the emergency stop point may be calculated by using the sensor data output from the inertial measurement unit and the sensor data output from the position sensor 21. This is because the deceleration of the lawn mower 10 suddenly becomes greater when the emergency stop is made. The emergency stop point is a point that the operator should beware of when the lawn mower 10 travels to mow the lawn.

The time required can be calculated by using the sensor data output from the position sensor 21 according to the operating time. That is, the time required can be calculated by measuring time from when the lawn mower 10 begins to be positioned in the operation area until it passes through all points in the operation area and leaves the operation area. The difficulty of mowing is evaluated by a predetermined policy to calculate it. For example, it is calculated based on the degree of the inclination of the operation area and the number of the emergency stop points.

By referring to the inclination of the operation area, the emergency stop point, the time required and the difficult of mowing, the user can make a suitable schedule for lawn mowing. For example, it is desirable to assign an experienced operator to the operation area with a large degree of the inclination, with many emergency stop points, or with high difficulty. It may also be desirable to assign two operators to handle the operation area that requires long time to mow. In addition, a contractor that provides lawn mowing may perform mowing on more than one lawn area in a single day. Therefore, by using the management system 1 to estimate the time required, the contractor can notify a customer of estimated time of arrival at the next lawn area.

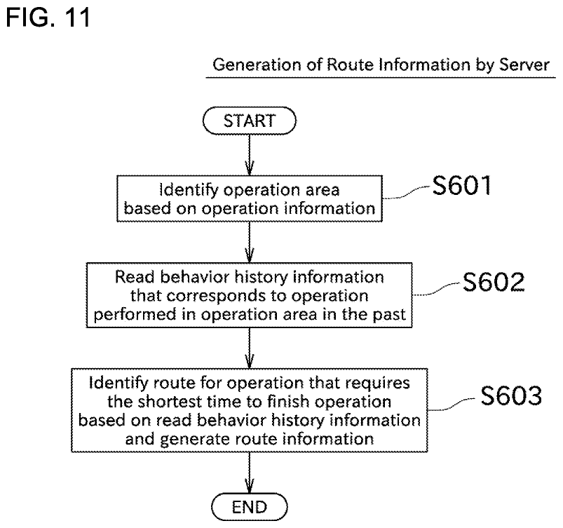

Then, with reference to FIG. 11, the process of generating the route information will be described below.

The server 30 performs a process of generating the route information with respect to the operation area included in the operation information received from the user terminal 40. For example, the server 30 generates the route information when it receives the operation information from the user terminal 40.

First, the server 30 identifies the operation area based on the operation information received from the user terminal 40 (S601). Next, the server 30 reads the behavior history information that corresponds to the operation performed in the identified operation area in the past (S602). The process performed in step S602 is equivalent to the process performed in step S502.

Then, based on the read behavior history information, the server 30 identifies a route for operation that requires the shortest time to finish the operation and generates the route information (S603). In the present embodiment, the server 30 suggests the route for operation that requires the shortest time to the user. The calculation method of the time required is as described in step S503. In this manner, the server 30 can identify the route for operation that requires the shortest time.

This allows the user to grasp the optimal route information based on the previous behavior history information.

The server 30 may generate the route information based on, for example, a route with low difficulty of mowing, instead of time required. Alternatively, the server 30 may generate the route information based on a route that was used by the same operator in the past. The server 30 may read the area analysis information in step S602 instead of the behavior history information. This simplifies the process performed by the server 30.

(Feature 1) As described above, the management system 1 of the present embodiment includes the electronic controller 14 and the communicator 15. The electronic controller 14 is arranged at the self-propelled lawn mower 10 and performs the drive control of the drive source 11 that drives the lawn mower 10. The communicator 15 is arranged at the lawn mower 10, includes an apparatus that communicates with the electronic controller 14 and communicates with the server 30 via a network, acquires the drive control information used for the drive control from the electronic controller 14, and transmits the drive control information to the server 30.

Transmitting the drive control information to the server 30 makes it easier to accumulate information necessary for the management than when only information on whether the lawn mower 10 is in operation is transmitted.

(Feature 2) In the management system 1 of the present embodiment, the communicator 15 transmits the drive control information via a mobile network to the server 30 while electricity is supplied to the electronic controller 14.

The drive control information can be transmitted to the server 30 in real time. Therefore, the process using the drive control information can be performed at an earlier time.

(Feature 3) In the management system 1 of the present embodiment, the communicator 15 transmits the behavior history information of the lawn mower 10 acquired from the electronic controller 14 to the server 30.

Since the behavior history information of the lawn mower 10 can be accumulated in the server 30, an operation history of the lawn mower 10, for example, can be registered.

(Feature 4) In the management system 1 of the present embodiment, the communicator 15 transmits the position of the lawn mower 10 acquired from the position sensor 21 arranged at the lawn mower 10 to the server 30.

Since the positions of the lawn mower 10 can be accumulated in the server 30, the area that the lawn mower 10 mowed the lawn or whether the lawn mower 10 is positioned in an appropriate area, for example, can be determined.

(Feature 5) In the management system 1 of the present embodiment, the electronic controller 14 determines whether the state of the drive source 11 is normal or abnormal. The communicator 15 transmits the results of the determination on the state of the drive source 11 made by the electronic controller 14 to the server 30.

This provides information for early response to a failure or maintenance of the drive source 11.

(Feature 6) In the management system 1 of the present embodiment, the communicator 15 transmits the identifier uniquely assigned to the lawn mower 10 in association with the drive control information to the server 30.

This allows the drive control information stored in the server 30 to be classified according to the identifier so that the organization and the utilization of the drive control information can be facilitated.

(Feature 7) The management system 1 of the present embodiment includes the server 30. The server 30 transmits information about lawn mowing to the user of the lawn mower 10 or to the dealer of the lawn mower 10.

This allows the user and the dealer of the lawn mower 10 to utilize the information consolidated on the server 30.

(Feature 8) In the management system 1 of the present embodiment, the communicator 15 transmits the identifier uniquely assigned to the lawn mower 10 in association with the drive control information to the server 30. The server 30 stores the user ID that identifies the user of the lawn mower 10 in association with the identifier or stores the dealer ID that identifies the dealer of the lawn mower 10 in association with the identifier.

The lawn mower 10 and the user or the dealer can be managed being linked to each other.

(Feature 9) In the management system 1 of the present embodiment, the server 30 collectively transmits the information about the more than one lawn mower 10 that the user uses to the use's client terminal or collectively transmits the information about the more than one lawn mower 10 that the dealer deals with to the dealer's client terminal.

In this manner, since the information required by the user or the dealer of the lawn mower 10 is collectively transmitted, this enables helpful assistance on management to be provided to the user or the dealer.

(Feature 10) In the management system 1 of the present embodiment, the server 30 communicates with the parts management system 60 that manages the provision of the parts of the lawn mower 10.

With this configuration, when a part of the lawn mower 10 needs to be replaced, for example, the information about the relevant part can be delivered.

(Feature 11) In the management system 1 of the present embodiment, the server 30 transmits the information about lawn mowing generated by processing the drive control information according to the user to the user's client terminal, i.e. the user terminal 40, or transmits the information about lawn mowing generated by processing the drive control information according to the dealer to the dealer's client terminal, i.e. the dealer client terminal 50.

This allows provision of different information according to the user or the dealer.

(Feature 12) In the management system 1 of the present embodiment, the server 30 transmits the maintenance information about the maintenance on the lawn mower 10 generated based on the drive control information to the user's user terminal 40 or to the dealer's dealer terminal 50.

The user or the dealer can perform the maintenance or the preparation thereof based on the maintenance information.

(Feature 13) In the management system 1 of the present embodiment, the server 30 receives the multiple pieces of the drive control information form more than one communicator 15. The server 30 generates the maintenance information by performing the failure prediction based on the multiple pieces of drive control information.

Since the failure prediction is performed by using multiple pieces of drive control information received from more than one communicator 15, the assistance on the maintenance can be provided with the failure prediction of high accuracy.

(Feature 14) In the management system 1 of the present embodiment, the communicator 15 transmits the position of the lawn mower 10 that is acquired from the position sensor 21 arranged at the lawn mower 10 to the server 30. The server 30 transmits the position received via the communicator 15 or the information obtained by analyzing the position to the user's user terminal 40 or the dealer's dealer terminal 50.

The position of the lawn mower 10 or the information based thereon can be provided to the user or the dealer. The information provided is, for example, the area that the lawn mower 10 mowed the lawn or whether the lawn mower 10 is positioned in the operation area.

(Feature 15) The management system 1 of the present embodiment includes the user terminal 40 used by the user of the lawn mower 10 that transmits the information about the management of the lawn mower 10 to the server 30. The management system 1 includes the dealer terminal 50 used by the dealer of the lawn mower 10 that transmits the information about the management of the lawn mower 10 to the server 30.

This allows information necessary for the management of the lawn mower 10 to be provided from the user or from the dealer as well.

(Feature 16) The management system 1 of the present embodiment includes the user terminal 40 used by the user of the lawn mower 10 transmits the identifier uniquely assigned to the lawn mower 10 and the user ID that identifies the user in association with each other to the server 30. The management system 1 includes the dealer terminal 50 used by the dealer of the lawn mower 10 transmits the identifier uniquely assigned to the lawn mower 10 and the dealer ID that identifies the dealer in association with each other to the server 30.

With this configuration, the identifier of the lawn mower 10 and the user ID or the dealer ID can be registered in association with each other, or the correspondence can be revised.

(Feature 17) In the management system 1 of the present embodiment, the communicator 15 transmits the behavior history information of the lawn mower 10 to the server 30. The server 30 generates the route for operation based on the behavior history information and transmits the route for operation to the user's user terminal 40.

An appropriate route for operation based on the previous operation history can be proposed to the user.

Features 1 to 17 described above can be combined as appropriate as long as no contradiction arises. For example, feature N (N=1, 2, . . . , 17) can be combined with at least one of features 1 to N−1 as appropriate.

While the preferred embodiment of the present application has been described above, the configurations explained above may be modified, for example, as follows.

As described above, the server 30 can generate various information based on the drive control information and the behavior history information. However, the information described above is disclosed merely as examples and the server 30 may generate other information. For example, the server 30 may generate operation history information for each operator based on the behavior history information and the operation information. The operation history information is information that includes, for example, the date and time of the operation, the operation area where the operator performed the operation, the route of the operation, and time required for the operator to mow the lawn. By referring to the operation history information, the user can properly evaluate the operator.

The management system 1 may include not only the user and dealer's client terminals but also the client terminal that belongs to the manufacturer of the lawn mower 10 or the drive source 11. In this case, the server 30 transmits the drive control information, the behavior history information, and the maintenance history information to the manufacturer. The manufacturer can use the information received from the server 30 to improve the lawn mower 10 or the drive source 11 or design a new model thereof.

The application of the management system 1 is not limited to the lawn mower 10, but it can be applied to other work machines. The other work machines are, for example, agricultural or construction machines.

The flowcharts indicated in the above-mentioned embodiment are disclosed merely as examples, and some processes may be omitted, some processes may be modified, and a new process may be added.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1-19. (canceled)

20. A management system, comprising:
an electronic controller arranged at a self-propelled lawn mower, the electronic controller performing a drive control of a drive source that drives the lawn mower; and
a communicator arranged at the lawn mower, the communicator including an apparatus that communicates with the electronic controller and communicating with a server via a network, the communicator acquiring drive control information used for the drive control from the electronic controller and transmitting the drive control information to the server.

21. The management system according to claim 20, wherein the communicator transmits the drive control information via a mobile network to the server while electricity is supplied to the electronic controller.

22. The management system according to claim 20, wherein the communicator transmits behavior history information of the lawn mower acquired from the electronic controller to the server.

23. The management system according to claim 20, wherein the communicator transmits a position of the lawn mower that is acquired from a position sensor arranged at the lawn mower to the server.

24. The management system according to claim 20, wherein the electronic controller determines whether a state of the drive source is normal or abnormal and wherein the communicator transmits a result of determination on the state of the drive source made by the electronic controller to the server.

25. The management system according to claim 20, wherein the communicator transmits an identifier uniquely assigned to the lawn mower in association with the drive control information.

26. The management system according to claim 20, comprising
the server transmitting information about lawn mowing to a user of the lawn mower or to a dealer of the lawn mower.

27. The management system according to claim 26, wherein the communicator transmits an identifier uniquely assigned to the lawn mower in association with the drive control information to the server, and wherein the server stores a user ID that identifies the user of the lawn mower in association with the identifier or stores a dealer ID that identifies the dealer of the lawn mower in association with the identifier.

28. The management system according to claim 27, wherein the server collectively transmits information about more than one lawn mower that the user uses to a user's client terminal or collectively transmits the information about more than one lawn mower that the dealer deals with to a dealer's client terminal.

29. The management system according to claim 26, wherein the server communicates with a parts management system that manages provision of a part of the lawn mower.

30. The management system according to claim 26, wherein the server transmits information about lawn mowing generated by processing the drive control information according to the user to a user's client terminal, or transmits information about lawn mowing generated by processing the drive control information according to the dealer to a dealer's client terminal.

31. The management system according to claim 26, wherein the server transmits maintenance information about maintenance on the lawn mower generated based on the drive control information to a user's client terminal or a dealer's client terminal.

32. The management system according to claim 31, wherein the server receives multiple pieces of the drive control information from more than one communicators, and wherein the server generates the maintenance information by performing failure prediction based on the multiple pieces of the drive control information.

33. The management system according to claim 26, wherein the communicator transmits a position of the lawn mower that is acquired from a position sensor arranged at the lawn mower to the server, and wherein the server transmits the position received via the communicator or information obtained by analyzing the position to a user's client terminal or a dealer's client terminal.

34. The management system according to claim 20, comprising:
a client terminal used by a user of the lawn mower or a dealer of the lawn mower, the client terminal transmitting information about management of the lawn mower to the server.

35. The management system according to claim 20, comprising:
a client terminal used by a user of the lawn mower or a dealer of the lawn mower, the client terminal transmitting an identifier uniquely assigned to the lawn mower and a user ID that identifies the user or a dealer ID that identifies the dealer in association with each other to the server.

36. The management system according to claim 20, wherein the communicator transmits behavior history information of the lawn mower to the server, and wherein the server generates a route for operation based on the behavior history information and transmits the route for operation to a user's client terminal.

37. A method for transmitting information about lawn mowing to a user or a dealer of a self-propelled lawn mower, comprising:
receiving a drive control information used for a drive control of a drive source that drives the lawn mower; and
transmitting information about lawn mowing generated by processing the drive control information according to the user to a user's client terminal or transmitting information about lawn mowing generated by processing the drive control information according to the dealer to a dealer's client terminal.

38. A management system, comprising:
an electronic controller arranged at a self-propelled work machine, the electronic controller performing a drive control of a drive source that drives the work machine; and
a communicator arranged at the work machine, the communicator including an apparatus that communicates with the electronic controller and communicating with a server via a network, the communicator acquiring drive control information used for the drive control from the electronic controller and transmitting the drive control information to the server.
